(19) United States
(12) Patent Application Publication
(10) Pub. No.: US 2025/0044309 A1
(43) Pub. Date: Feb. 6, 2025

(54) ARRANGEMENT AND METHOD FOR SEPARATING A SINGLE TEST STRIP

(71) Applicant: OLYMPUS WINTER & IBE GMBH, Hamburg (DE)

(72) Inventors: Alexander Werner, Bielefeld (DE); Martin Schnieders, Bielefeld (DE); Celina Werner, Bochum (DE); Gregor Goldberg, Warendorf (DE)

(73) Assignee: OLYMPUS WINTER & IBE GMBH, Hamburg (DE)

(21) Appl. No.: 18/792,854

(22) Filed: Aug. 2, 2024

Related U.S. Application Data
(60) Provisional application No. 63/530,500, filed on Aug. 3, 2023.

(51) Int. Cl. G01N 35/00

(52) U.S. Cl. CPC G01N 35/00029; G01N 2035/00039; G01N 2035/00108

(57) ABSTRACT

An apparatus for separating a single test strip from a test strip depot containing a plurality of test strips including: a stock containing the plurality of test strips; an output position for the single test strip; an outlet opening; and an output mechanism configured to output the single test strip positioned in the output position through the outlet opening upon activation of the output mechanism.

### CROSS-REFERENCE TO RELATED APPLICATION

The present application is based upon and claims the benefit of priority from U.S. Provisional Application No. 63/530,500 filed on Aug. 3, 2023, the entire contents of which is incorporated herein by reference.

The present application is related to the following co-pending U.S, Applications, each filed on Aug. 2, 2024, U.S. patent application Ser. No. 18/xxx,xxx (corresponding to U.S. Provisional Patent Application 63/530,490); U.S. patent application Ser. No. 18/xxx,xxx (corresponding to U.S. Provisional Patent Application 63/530,492); U.S. patent application Ser. No. 18/xxx,xxx (corresponding to U.S. Provisional Patent Application 63/530,496); and U.S. patent application Ser. No. 18/xxx,xxx (corresponding to U.S. Provisional Patent Application 63/530,504); the entire contents of each of which is incorporated herein by reference.

### BACKGROUND

### Field

The present disclosure relates to an arrangement for separating a single test strip, such as a test strip for measurement of a concentration of peracetic acids, from a test strip depot, a reprocessing apparatus for medical instruments, and a method for separating a single test strip, such as a test strip for measurement of a concentration of peracetic acids, from a test strip depot.

### Prior Art

Test strips, such as test strips for measurement of a concentration of peracetic acids, are often used in analysis units for detecting cleaning, sterilization and/or disinfection agents. Such analysis units may be used, for example, in water-bearing household appliances are known, for example, from DE102009027950 A1. This document relates to a household device having a control device for performing rinse cycles, which are adjusted by the control device using cleaning agents e.g. additives. An analyzing unit detects the cleaning agents and is provided with a reading unit for radio frequency identification of barcode or other identification marks printed on the cleaning agents. The analyzing unit is connected with the control device for transmitting analyzing data from the analyzing unit to the control unit.

Furthermore, EP 3302210 B1 discloses a device and a method for determining the composition of the dirt load in a rinsing or detergent solution in a water-using household appliance, for example in a dishwasher, using near infrared spectroscopy (NIR).

Patent application DE 19806559 B4 discloses a method involving emitting rays into a dish stack, determining and/or recording a quantity or rays of at least one wavelength range, leaving the stack under respectively one predetermined angle, assuming a kind and a concentration of a pollution ratio and/or a cleaner ratio of the dish stack, and optimizing a dish washer program, accordingly. A corresponding dish washer arrangement is also disclosed.

Patent application DE 102007011119 A1 relates to a washing machine with an automatic controller for washing process and optical sensor devices. The optical sensor devices transmit signals, which are evaluated for controlling the washing process. The optical sensor devices detect light intensities of different spectral regions. The optical sensor devices are sensitive over the entire spectral region from infrared to ultraviolet. The optical sensor devices are arranged at a bypass such that the optical sensor devices measure characteristics of detergent components in different positions.

Existing solutions to use test strips for measurement of a concentration of peracetic acids, are in analysis units for detecting cleaning, sterilization and/or disinfection agents, however, usually are comparatively expensive and often require to be fully or partially operated by hand. Furthermore, they may be not always accurate and robust against operating errors typically occurring during manual operation.

### SUMMARY

Therefore, an object is to provide a solution, which reduces or eliminates one or more of the above-mentioned disadvantages. For example, an object is to provide an improved arrangement and method for separating a single test strip. For example, an object is to provide an improved arrangement and an improved method for separating a single test strip for measurement of a concentration of peracetic acids from a test strip depot, which is reliable, cost-efficient, and insensitive to storage and operation errors.

According to a first embodiment, an arrangement for separating a single test strip, such as a test strip for measurement of a concentration of peracetic acids, from a test strip depot is provided. The arrangement comprising a stock containing a plurality of test strips in a, for example vertically, stacked manner, an output position for a single test strip such as, the lowest position in the stack of test strips, an outlet opening, an output mechanism configured to output the single test strip, such as by pushing, positioned in the output position through the outlet opening upon activation of the output mechanism.

In the following, initially the arrangement for separating a single test strip and its components, functions and advantageous embodiments will be described.

Reprocessing as used herein may comprise all steps necessary to reuse previously used medical instruments, including removing blood, tissue and other biological debris and inactivating infectious microorganisms and/or viruses. For example, reprocessing may encompass, but is not limited to, initial basic and subsequent thorough cleaning, and/or disinfecting, and/or sterilizing the medical instruments using suitable cleaning, and/or disinfecting, and/or sterilizing agents. Reprocessing may also encompass re-packaging and of terminally sterilizing the previously cleaned, and/or disinfected, and/or sterilized medical instruments. Reprocessing agents may comprise reprocessing chemicals, for example peracetic acids. A reprocessing cycle may encompass a procedure, carried out, for example, in a reprocessing apparatus, used to reprocess a medical instrument between two uses. A reprocessing cycle may encompass a process of cleaning and/or rinsing and/or disinfection and/or sterilization.

Medical instruments as used herein can encompass endoscopes and/or probes, for example, and further specified medical instruments that may be reusable, such as reusable endoscopes and/or reusable probes.

The reprocessing of medical instruments is particularly sensitive for the safety of medical procedures using such medical instruments and thus highest requirements for the reliability of such reprocessing apply. For example, the requirements in reprocessing medical instruments differ from and exceed those for water-bearing household appliances, such as dishwashers and washing machines, by far and significantly. Therefore, solutions for such water-bearing household appliances are not suitable or sufficient for the requirements applying to the reprocessing of medical instruments between different medical procedures on different patients.

In order to ensure reliability and accuracy of reprocessing procedures and/or in order to monitor and/or document the conditions of reprocessing procedures, arrangements for measuring a concentration of reprocessing agents in a reprocessing liquid used in a reprocessing apparatus for medical instruments may be applied. Such an arrangement can comprise a measuring system which can be configured to evaluate a test surface of a test strip that has been exposed to a dose of reprocessing liquid.

The solution described herein considers that the handling of test strips, such as during dosing and measuring, can be partly or fully automated. Handling of test strips may comprise movement of test strip, such as to and from a first, dosing position and a second, measuring position and/or e release and/or supply of test strips to a measuring system and/or transport of test strips. However, test strips are usually provided as a bundle of a plurality of test strips, for example in a test strip depot. For measuring, however, only a single test strip at a time needs to be employed. Therefore, a single test strip needs to be separated from the plurality of test strips, which is usually done manually. The solution described herein can be utilized since it allows to handle, such as separate, a single test strip from a test strip depot.

The arrangement for separating a single test strip, such as a test strip, for measurement of a concentration of peracetic acids, from a test strip depot provided herein can thus comprise an output mechanism configured to, upon its activation, output one single test strip through an outlet opening, such as by pushing.

The arrangement for separating a single test strip, such as a test strip for measurement of a concentration of peracetic acids, from a test strip depot can have several advantages. For example, the arrangement can provide a cost-efficient way to store test strips for measurement of a concentration of peracetic acids while also protecting them from environmental influences. The arrangement can be operable fully automatically and provide a reliable way to periodically separate single test strips from a depot of test strips.

The output mechanism of the arrangement can comprise a force transmission, which can be moveable from an idle position to an activation position and can be configured to activate the output mechanism upon its movement to the activation position. Such embodiment can have the advantage of offering a reliable solution to activate output mechanism.

The force transmission can be biased in the idle position, such as via a spring. The force transmission can protrude from the depot or a housing of the arrangement in the idle position. Such embodiment can have the advantage of providing easy access to and quick operation of the arrangement. Additionally, the force transmission protruding from the depot or housing of the arrangement in the idle position can also have the advantage of the arrangement being ready for use, without the need for any additional setup or adjustments. Further, the protrusion of transmission from the depot or housing can make it accessible for another unit, e.g. a gripper, to move the force transmission from the idle position to the activation position.

The force transmission of the arrangement can be connected to a linkage. The linkage can be supported centrally on a pivot point and connected to a test strip pusher. The linkage can be configured to move about the pivot point when the force transmission element is moved in a first direction and to transmit the movement of the force transmission element into a movement of the test strip pusher in a second, opposite direction, with the test strip pusher being configured to push the test strip in the opposite direction. This embodiment can have the advantage of providing smooth movement of the test strip pusher and thus reducing the risk of damage to the test strip.

The force transmission can comprise a force introduction element connected to a force transmitter. The force introduction element can be supported by a spring, such as against a portion of the stock or the housing of the arrangement. The linkage can be connected to the force transmitter and the test strip pusher. This can have the advantage of providing a direct force transmission pathway to the force introduction element. The stock can comprise an openable cover for refilling the stock with test strips. An openable cover can have the advantage of providing a protected space for the test strips to keep out potentially harmful substances.

The arrangement can comprise a test strip pusher guide configured to allow a movement path of the linkage of the test strip pusher. The test strip pusher can be configured to push the single test strip in the output position through the outlet opening. In this way, smooth movement of the test strip pusher without derailing can be ensured.

Further, the arrangement can be configured to periodically provide an individual test strip from a depot of test strips.

In a further embodiment, the output mechanism of the arrangement can be configured to output the single test strip such that the test strip can be removed from the outlet opening. The test strip can be removed by a gripper. A gripper may be part of a transport arrangement suitable for transporting separated test strips to a measurement system of an arrangement for measuring a concentration of reprocessing chemicals in a reprocessing liquid used in a reprocessing apparatus for medical instruments. This can have the advantage of offering a fully automatic operation of an arrangement for separating an individual test strip from a depot of test strips.

According to a second embodiment, an arrangement for measuring a concentration of reprocessing chemicals in a reprocessing liquid used in a reprocessing apparatus for medical instruments is provided. The arrangement comprising an arrangement for separating a single test strip from a test strip depot according to at least one of the previously described embodiments. This can have the advantage of offering a fully automatic measurement of a concentration of reprocessing chemicals. According to a third embodiment, a reprocessing apparatus for medical instruments is provided. The reprocessing apparatus comprising a reprocessing chamber, a reprocessing circuit, an arrangement for measuring a concentration of reprocessing chemicals in a reprocessing liquid or an arrangement for separating a single test strip from a test strip depot according to one of the previously described embodiments of the arrangement. The reprocessing apparatus can reduce the risk of contamination or damage to the instrument and thus allow accurate and efficient reprocessing of medical instruments.

According to a fourth embodiment, a method for separating a single test strip, such as a test strip for measurement of a concentration of peracetic acids, from a test strip depot is provided. The method comprising providing a plurality of test strips in a, for example, vertically, stacked manner, such as in a stock, and activating an output mechanism to output, for example to push, a single test strip positioned in an output position, such as the lowest position in the stack of test strips, for example through an outlet opening. This can have the advantage of reducing the risk of wasting or damaging multiple test strips. Furthermore, it can have the advantage of saving space and facilitating easy storage of test strips. A further advantage can be that easy access to an individual, separated test strip is provided.

In the following, details, functions and embodiments of the method and arrangement for separating a single test strip, such as a test strip for measurement of a concentration of peracetic acids, from a test strip depot, will be described.

In an embodiment, the method comprises moving a force transmission from an idle position to an activation position to activate the output mechanism, wherein the movement of the force transmission from the idle position to the activation position can be induced by a gripper. The force transmission can push the single test strip in the outlet position through the outlet opening, such as by the test strip pusher. The force transmission can remove the single test strip from the outlet opening, such as by the gripper. This can have the advantage of providing a fully automatic, reliable method for the, for example periodical, separation of individual test strips.

In a further embodiment, the method can comprise moving, such as pivoting, a linkage connected to the force transmission and to a test strip pusher about a central pivot point when the force transmission element is moved in a first direction. The force transmission can transmit the movement of the force transmission element into a movement of the test strip pusher in a second, opposite direction, with the test strip pusher pushing the test strip in the opposite direction. This embodiment can have the advantage of providing a method for smoothly separating a single test strip from a stack of test strips and thus avoiding damage to the test strip.

In another embodiment, the method can comprise returning the force transmission to its idle position, such as by a spring, after the test strip is removed, such as when the gripper unit moves away from the force transmission. This can have the advantage of providing a method for automatically returning the force transmission into its idle state without requiring manual reset or the use of electrical power sources.

According to an embodiment, another, second, test strip from the stack of test strips can move into the output position, such as, by gravity, after the singe test strip has been outputted, and for example, has been removed. This can have the advantage of providing a method for automatically providing a next test strip without requiring manual refilling or the use of electrical power sources.

As to the advantages, embodiments and details of the individual different embodiments, reference is also made to the corresponding advantages, embodiments and details described with reference to the respective other embodiments.

Further embodiments result from the combination of individual, several or all of the features described herein.

### BRIEF DESCRIPTION OF THE DRAWINGS

The embodiments are described with reference to the attached drawings, in which

FIG. 1 illustrates a schematic depiction of an exemplary prior art reprocessing apparatus for medical instruments;

FIG. 2 illustrates a schematic depiction of an exemplary embodiment of a reprocessing apparatus for medical instruments;

FIG. 3 illustrates a schematic depiction of an arrangement for measuring a concentration of reprocessing agents in a reprocessing liquid used in the reprocessing apparatus for medical instruments of FIG. 2 in more detail;

FIG. 4 illustrates a schematic depiction of an exemplary embodiment of an arrangement for separating a single test strip for measurement of a concentration of peracetic acids from a test strip depot in an idle state;

FIG. 5 illustrates the arrangement for separating a single test strip of in FIG. 1 upon activation of the output mechanism;

FIG. 6 illustrates the arrangement for separating a single test strip of in FIG. 1 upon gripping the test strip;

FIG. 7 illustrates the arrangement for separating a single test strip of in FIG. 1 after removal of the single test strip;

FIG. 8 illustrates the arrangement for separating a single test strip of in FIG. 1 again in the idle position with a new test strip in the output position;

FIG. 9 illustrates a schematic flow diagram of an exemplary method for separating a single test strip for measurement of a concentration of peracetic acids from a test strip depot.

### DETAILED DESCRIPTION

In the figures, elements with the same or comparable functions are indicated with the same reference numerals.

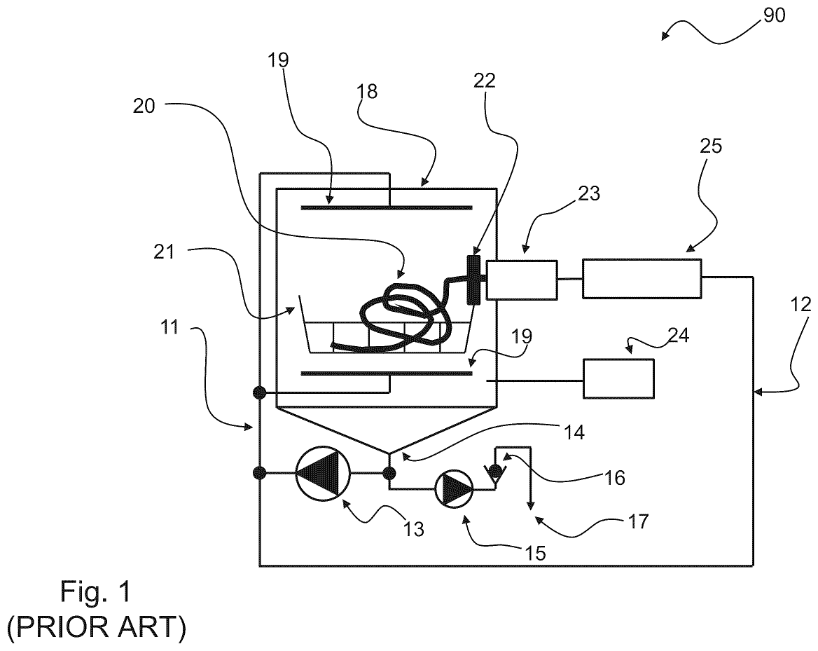

FIG. 1 shows a schematic layout of an exemplary prior art reprocessing apparatus 90 for medical instruments 20, for example endoscopes. The apparatus 90 may comprise a reprocessing chamber 18, in which a loading carrier 21 containing medical instruments 20 to be cleaned and/or disinfected and/or sterilized may be placed. Reprocessing liquid may be circulated in the apparatus 90 via circulation pump 13 and pump sump 14 in an outer reprocessing circuit 11 and an inner reprocessing circuit 12. The outer reprocessing circuit 11 may circulate the reprocessing liquid in the processing chamber 18 via at least one, such as, via two spray arms 19, as shown in FIG. 1. The inner reprocessing circuit 12 may circulate the reprocessing liquid via monitoring unit 25, loading carrier 21 and loading carrier coupling 23 to the inner channels of medical instruments 20 located in loading carrier 21. A dosing system 24 may be provided for dosing reprocessing agents to the reprocessing liquid in the reprocessing chamber 18. Pump sump 14 may be connected to a drain pump 15, which in turn may be connected to a check valve 16 and a structural drain 17.

The inner reprocessing circuit 12 connects the loading carrier 21 to the structural drain 17. The inner reprocessing circuit 12 may comprise a monitoring unit 25, which may be connected to the loading carrier 21 via a loading carrier coupling 23 comprising an adapter plate 22. The monitoring unit 25 may further be connected to the circulation pump 13, and thus to the subsequent elements following the circulation pump, namely the drain pump 15, the check valve 16, and the structural drain 17.

The monitoring unit can be a “flow control,” which can be a dedicated module that monitors for blockages and dropped adapters. Such monitoring can operate by analyzing pressure differences. The values of which can be communicated via a so-called type list. The monitoring unit therefore also includes sensors, such as pressure sensors.

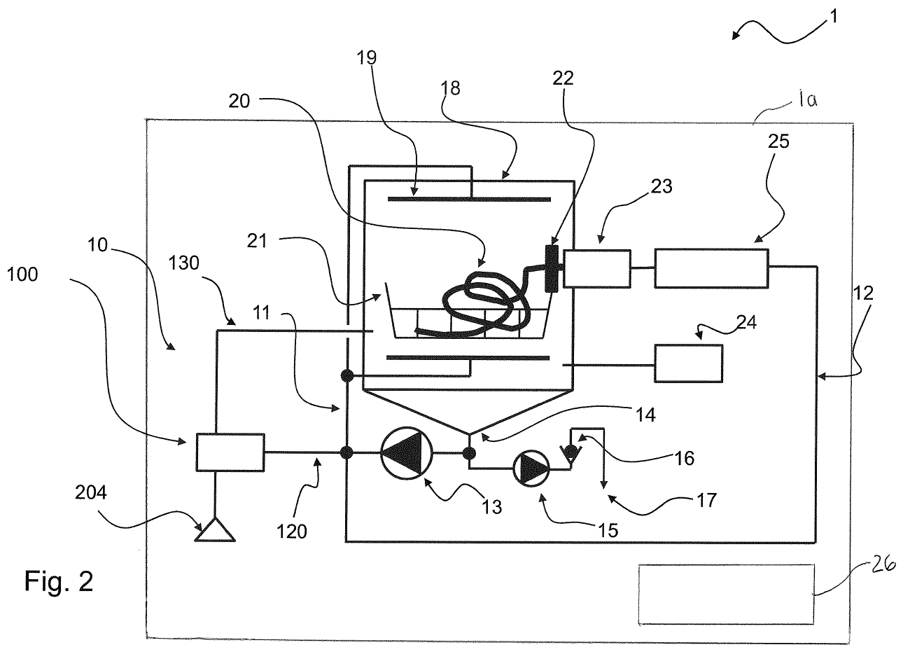

FIG. 2 shows a schematic layout of an exemplary embodiment of a reprocessing apparatus 1 for medical instruments 20, for example endoscopes. The individual components of the reprocessing apparatus 1, as discussed below, can be under the control of a controller 26 for carrying our such reprocessing. Also reprocessing apparatus 1 may comprise a reprocessing chamber 18, in which a loading carrier 21 containing medical instruments 20 to be cleaned and/or disinfected and/or sterilized may be placed. Reprocessing liquid may be circulated in the reprocessing apparatus 1 via circulation pump 13 and pump sump 14 in an outer reprocessing circuit 11 and an inner reprocessing circuit 12. The outer reprocessing circuit 11 may circulate the reprocessing liquid in the processing chamber 18 via least one, such as two spray arms 19. The inner reprocessing circuit 12 may circulate the reprocessing liquid via monitoring unit 25, loading carrier 21 and loading carrier coupling 23 to the inner channels of medical instruments 20 located in loading carrier 21. A dosing system 24 may be provided for dosing reprocessing agents to the reprocessing liquid in the reprocessing chamber 18. Pump sump 14 may be connected to a drain pump 15, which in turn may be connected to a check valve 16 and a structural drain 17.

The inner reprocessing circuit 12 connects the loading carrier 21 to the structural drain 17. The inner reprocessing circuit 12 may comprise a monitoring unit 25, which may be connected to the loading carrier 21 via a loading carrier coupling 23 comprising an adapter plate 22. The monitoring unit 25 may further be connected to the circulation pump 13, and thus to the subsequent elements following the circulation pump, namely the drain pump 15, the check valve 16, and the structural drain 17.

The reprocessing apparatus 1 differs from existing reprocessing apparatus 90 for example in an arrangement (apparatus) 10 for measuring a concentration of reprocessing agents in a reprocessing liquid and a compressed air supply 204.

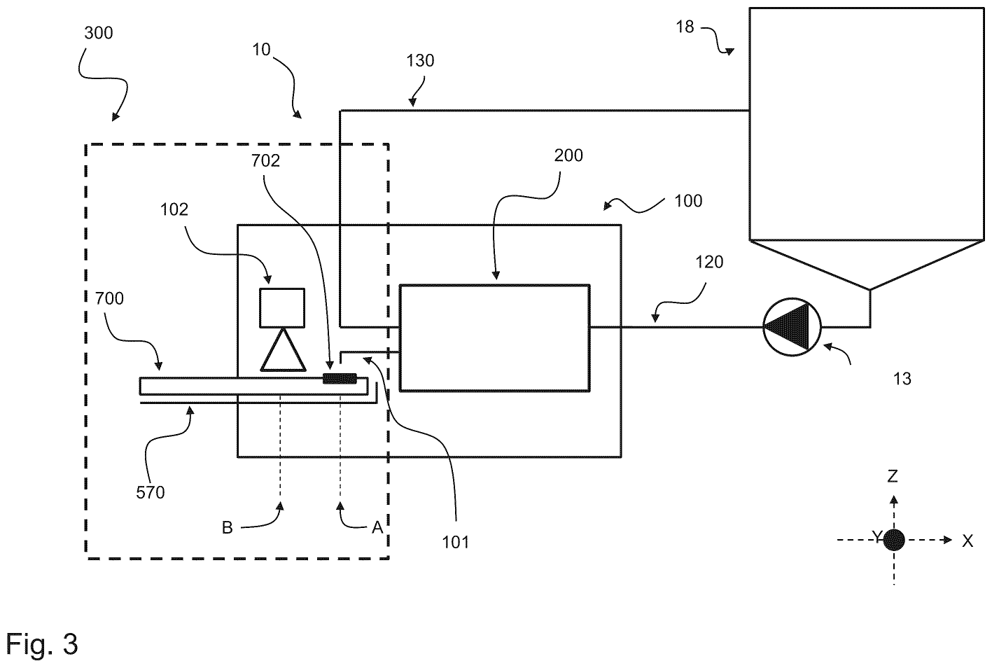

FIG. 3 shows a schematic depiction of an arrangement 10 for measuring a concentration of reprocessing agents in a reprocessing liquid used in the reprocessing apparatus 1 for medical instruments of FIG. 2 in more detail.

The arrangement 10 comprises a measuring system 100 connected to the reprocessing circuits 11, 12, such as to the circulation pump 13, via a first conduit 120 hydraulic connection of the measuring system. Furthermore, the measuring system 100 is connected to the reprocessing chamber 18 via a second conduit 130 for a bypass connection. The first and second conduits can form a bypass circuit for reprocessing liquid to be fed through measuring system 100. The measuring system 100 may be further connected to a compressed air supply 204.

During operation of the apparatus 1, one or several medical instruments 20 are placed into the loading carrier 21 and connected via the adapter plate 22 and the loading carrier coupling 23 to the inner reprocessing circuit 12 for rinsing the inner channel(s) of the medical instrument(s) 20 with reprocessing fluid.

The reprocessing chamber 18 may be filled with reprocessing liquid containing a reprocessing agent using spray arms 19 via the outer reprocessing circuit 11. The reprocessing chamber 18 may hold the reprocessing liquid for a predetermined amount of time. Alternatively and/or additionally, the circulation pump 13 may be used to re-circulate the reprocessing liquid containing the reprocessing agent by pumping it via the circulation pump 13 from the pump sump 14 to the spray arms 19 in the outer reprocessing circuit 11 and/or to the inner channel(s) of the medical instrument(s) 20 in the inner reprocessing circuit 12 for a pre-determined amount of time and/or number of cycles.

During cycling, reprocessing liquid may be taken from the outer reprocessing circuit 11 via the first conduit 120 to supply it to the measuring system 100, in which the concentration of the reprocessing agent in the reprocessing liquid is measured.

Dosing unit 24 may supply additional reprocessing agent according to the measurements of measuring system 100. The dosing unit may be an actuator, such as a motor, under the control of the controller. Such controller can be the same or separate from the controller for the reprocessing apparatus. After measuring the concentration of the reprocessing agent, the remaining reprocessing liquid may be fed back to the outer reprocessing circuit 11 via the second conduit 130.

At the end of a reprocessing procedure, such as after a pre-determined amount of time and/or number of recirculation cycles with a required concentration of reprocessing agents in the reprocessing liquid, the reprocessing chamber 18 may be emptied via the structural drain 17 by using the drain pump 15 for pumping the time liquid through the check valve 16 into the structural drain 17.

The measuring system 100 may be located outside of a housing 1a of the apparatus 1 or may have an interface on an outer periphery of the apparatus 1.

The measuring system 100 is configured to receive a test strip 700 with a test surface 702 and to position the test strip 700 in a first, dosing position A and a second, measuring position B, both located along a test strip guide 570, as can be seen in FIG. 3. The measuring system 100 is further configured to dose a predetermined amount of reprocessing liquid onto the test surface 702 when the test strip 700 is positioned in the first, dosing position A via a reprocessing liquid feed system and a sample feed line 101 connected thereto.

The measuring system 100 can comprise an evaluating unit 102 for measuring the concentration of reprocessing agents in the reprocessing liquid when the test strip 700 is positioned in the second, measuring position B by evaluating the test surface 702. The evaluating unit 102 may comprise an optical spectrometer and/or an RGB color sensor, and the evaluating unit 102 may adapted to compare the evaluation result with a reference value. For example a characteristic, such as a color characteristic, of the test surface 702 may be determined, and compared with a reference characteristic. The predetermined amount of reprocessing liquid may act on the test surface 702 for a predetermined exposure time before evaluating the test surface 702. After evaluating the test surface 702, the test strip 700 is released.

The arrangement 10 for measuring a concentration of reprocessing agents in a reprocessing liquid used in a reprocessing apparatus 1 for medical instruments 20, can further comprise a transport arrangement 300 for transporting a test strip 700. The transport arrangement 300 may be used for transporting a test strip 700. A single test strip 700 can be transported.

The arrangement 10 for measuring a concentration of reprocessing agents in a reprocessing liquid used in a reprocessing apparatus 1 for medical instruments 20, can further comprise a reprocessing liquid feed system 200 for dosing a predetermined amount of reprocessing liquid onto a test surface 702 of a test strip 700.

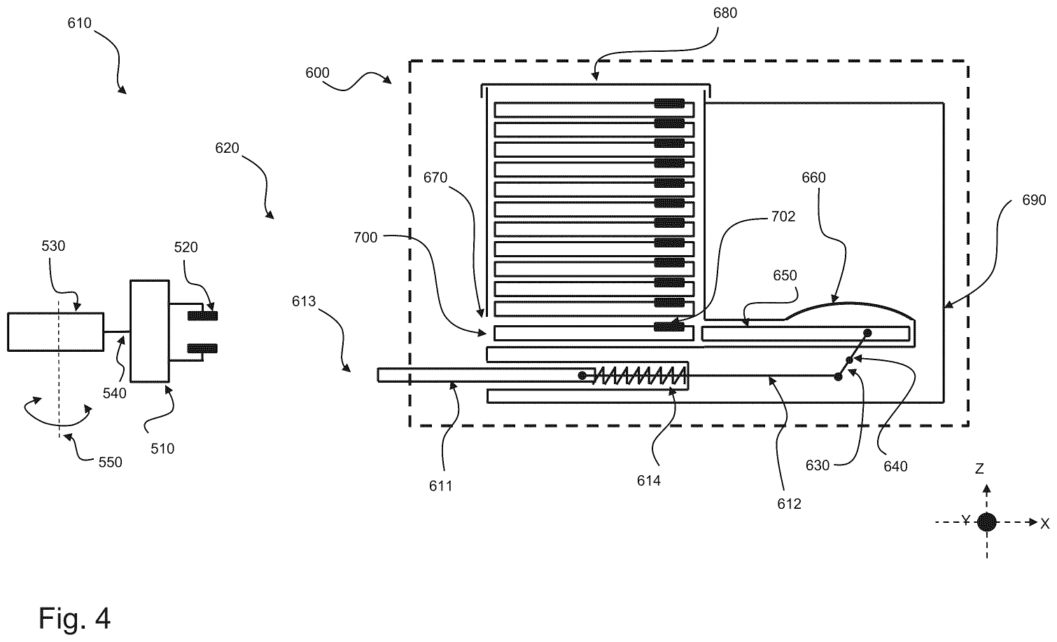

The arrangement 10 for measuring a concentration of reprocessing agents in a reprocessing liquid used in a reprocessing apparatus 1 for medical instruments 20, can further comprises an arrangement (apparatus) 610 for separating a single test strip, such as a test strip for measurement of a concentration of peracetic acids, from a test strip depot 600 shown in more detail in FIGS. 4 through 8.

FIG. 4 shows a schematic depiction of an exemplary embodiment of an arrangement 610 for separating a single test strip 700 for measurement of a concentration of peracetic acids from a test strip depot 600 in an idle state.

The arrangement 610 may be contained within a housing. The housing may be sized and shape to contain the whole of the arrangement 610. Furthermore, the housing may be constructed from any suitably robust material that is configured to withstand adverse conditions. Such conditions may include an atmosphere with high humidity or an atmosphere with a significant amount of cleaning and/or disinfection agents.

Furthermore, the arrangement 610 may comprise a stock 690 for storing a plurality of test strips 700. The stock 690 may also comprise an openable cover 680 for refilling the stock 690 with test strips 700. The openable cover 680 and the stock 690 may be made from a suitable robust material, configured to withstand adverse conditions, such as atmosphere with high humidity or an atmosphere with a significant amount of cleaning and/or disinfection agents. Materials may include plastic or metal. The openable cover 680 may be connected with the stock 690, in such a way that the depot may be sealed in a water-tight and/or air-tight manner. The stock 690 may be of a size and shape to store a suitable number of test strips 700. The test strips 700 may be stored in a vertically stacked manner inside the stock 690. However, test strips 700 may also be stored in any other suitable way.

The arrangement 610 may further comprise an outlet opening 670, through which one or more test strips 700 may be removed from the stack of test strips 700. The outlet opening 670 may be configured to allow a test strip 700 to pass therethrough. For example, the outlet opening 670 may be configured to allow only a single test strip 700 at a time to pass therethrough. The outlet opening 670 may be located at any suitable position of the arrangement 610. The outlet opening 670 may be part of the stock 690 or the housing. Further, the outlet opening may be positioned near the bottom of the stock 690, such that the test strip 700 in the lowest position of the stack of test strips 700, only the test strip 700 in the lowest position of the stack of test strips 700, may pass through the outlet opening 670. The outlet opening 670 may be a part of the stock 690, for example as a cutout in a wall of the stock 690 and/or the housing or as a component additionally adapted to the cutout. This component may be of the same material as the stock 690 and/or housing, but may also be of another suitable material (e.g., soft silicone or plastic) that may be subsequently bonded to the cutout. Additionally, this component may also be configured to substantially protect the outlet opening 670 from the entry of interfering substances through the outlet opening 670 into the stock 690. In other words, the outlet opening 670 may be configured such that, while at least one test strip 700 may be removed, little or no substance may enter from the outside. This can be achieved by suitable design of the component at the outlet opening 670, such as rubber lips. These substances can be fluids such as water or cleaning agents, or other interfering substances.

Furthermore, the arrangement 610 may comprise an output position for a single test strip 700. For example, the output position may be the position of the test strip 700 which is to be outputted through the outlet opening 670. The output position may be the lowest position of test strip 700 in the stack of test strips 700.

The arrangement 610 may further comprise an output mechanism 620 configured to output a single test strip 700 in the output position through the outlet opening 670 upon activation of the output mechanism. The mechanism may push the test strip 700 through the outlet opening 670.

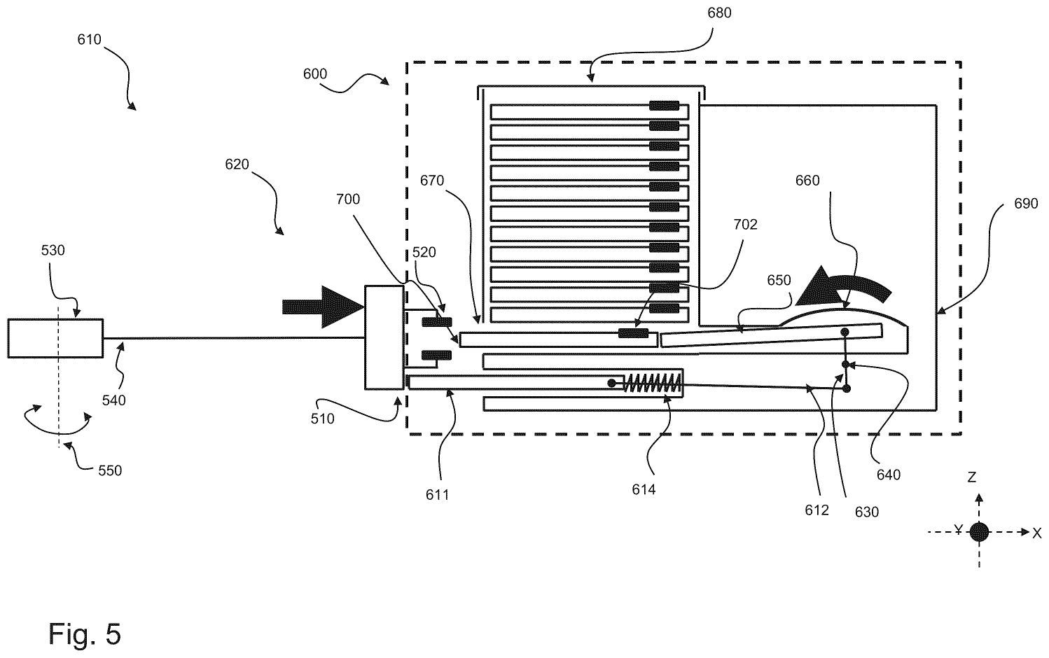

The output mechanism of the arrangement 610 may comprise a force transmission 613. The force transmission 613 may be made of the same or a different material as the stock 690 and/or the housing of the arrangement 610. The force transmission 613 may be moveable from an idle position, as depicted in FIG. 4, to an activated position, as depicted in FIG. 5.

In some embodiments, the force transmission 613 may be a singular unit. In some embodiments, the force transmission 613 may comprise multiple components. In the exemplary embodiment depicted in FIGS. 4 through 8, the force transmission 613 may comprise at least a force introduction element (member) 611 connected to a force transmitter 612. Force introduction element 611 may be substantially larger than the force transmitter 612. However, in some embodiments both force introduction element 611 and the force transmitter 612 may be of the same size and shape. Force introduction element 611 may be made of a material suitably robust against corrosion in humid atmospheres or atmospheres containing a substantial amount of cleaning and/or disinfection agents. The force transmitter 612 may be made of the same or a different material.

The force transmission 613 may furthermore comprise a spring 614. In its idle position, the force transmission 613 may be biased by the spring 614. In some embodiments, only the force introduction element 611 may be biased or supported by the spring 614 in the idle position. Further, the force transmission 613 may be supported or biased against a static portion of the stock 690 or the housing. In its idle position, the force transmission 613 may protrude partially or fully from the stock 690 or the housing of the arrangement 610, such as in a substantially horizontal direction. In some embodiments, only the force introduction element 611 may protrude from the stock 690 or the housing of the arrangement 610.

The force transmission 613 may be connected to a linkage 630. In some embodiments, the linkage 630 may be connected to the force transmitter 612. The linkage 630 may be made of the same or a different material as the force transmission 613. The linkage 630 may furthermore be supported on a pivot point 640, such as being centrally supported on a central pivot point. One end of the linkage 630 may be connected to the force transmission 613, such as to the force transmitter 612. The other end of the linkage 630 may be connected to a test strip pusher 650.

The linkage 630 may be configured to move about the pivot point 640 when the force transmission 613, such as the force introduction element 611, is moved in a first, for example substantially horizontal, direction and to transmit the movement of the force transmission 613, such as the force introduction element 611, into a movement of the test strip pusher 650 in a second, for example substantially horizontal, opposite direction, with test strip pusher 650 being configured to push the test strip 700 in the opposite direction.

In some embodiments, the linkage 630 may be configured to move about the central pivot point 640 when the force introduction element 611 is moved in a first, substantially horizontal, direction and to transmit the movement of the force transmission introduction element 611 via the force transmitter 612 into a movement of the test strip pusher 650 in a second, substantially horizontal, opposite direction.

The test strip pusher 650 may be configured to push a test strip 700 from the stock 690 in the opposite direction. The test strip pusher 650 pushes a single test strip 700 in the opposite direction. Test strip pusher 650 can push the lowest test strip 700 of the stack of test strips 700, such as the test strip 700 in the output position, in the opposite direction.

During movement, the linkage 630 may be guided by a test strip pusher guide 660 which is configured to allow a movement path of the linkage 630 of the test strip pusher. Test strip pusher guide 660 may be connected to a part of the stock 690 and/or the housing of the arrangement 610 and may be made the same material as the force transmission apparatus 610. Test strip pusher guide 660 may be configured to allow a movement path of the linkage 630 connected to the test strip pusher 650. In some embodiments, the movement path can be partly curved, e.g. in the form of a circular segment. In some embodiments, the movement path can be at least partly straight.

The test strip pusher 650 may furthermore push the test strip 700 from the output position through the opening 670 of the stock 690 and/or an opening of the housing. After this test strip being pushed through the opening 670 of the stock 690 and/or the opening of the housing, another test strip, such as the next lowermost test strip, may move into the output position.

Outputting, such as by pushing, the test strip may involve the test strip 700 being pushed to a position that is substantially outside of the stock 690 and/or the housing of the test strip depot 600. In some embodiments, a substantial portion of the length of the test strip 700 may be outside the stock 690 and/or the housing of the arrangement 610. The substantial portion of the length of the test strip 700 may be at least 20%, at least 30%, at least 40%, at least 50%, at least 60%, at least 70%, or at least 80% of the test strip's total length. The length of the test strip 700 protruding from the stock 690 and/or the housing of the arrangement 610 can be a length that allows the test strip 700 to be removed from the outlet opening 670 and/or the opening of the housing, for example by a gripper 510 of a transport arrangement 300.

The arrangement 610 may furthermore comprise or may be operated in connection with a gripper 510 of a transport arrangement 300. The gripper 510 may comprise gripper jaws 520. The gripper 510 may be connected to a linear drive 530 via a coupling rod 540. Further, the gripper 510 is arranged rotatably about a rotation axis 550 via a rotational drive. The gripper 510 may be configured to remove the test strip 700 from an output position as described above. The gripper jaws 520 may be configured to grip the test strip 700 protruding from the outlet opening 670 and/or the opening of the housing. The linear and rotational drives may be configured by one or more actuators, such as a motor, under the control of the controller. Such controller can be the same controller as that which controls the reprocessing apparatus or separate therefrom.

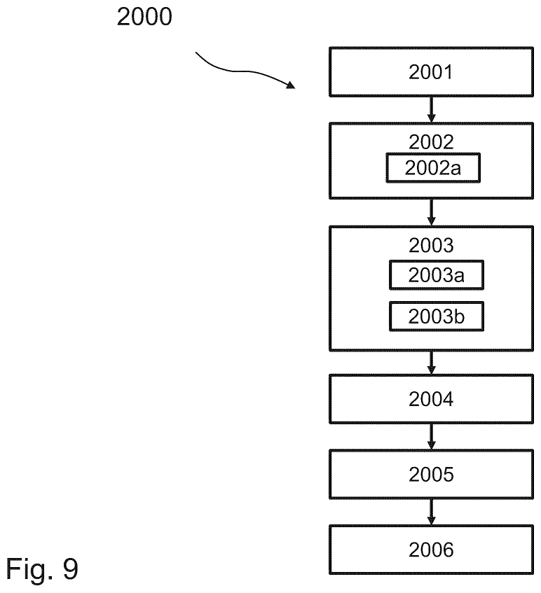

FIG. 9. shows a schematic flow diagram of an exemplary method 2000 for separating a single test strip, from a test strip depot. Arrangement 610 may be used to carry out method 2000.

Method 2000 may commence with the step 2001 of comprising providing a plurality of test strips 700 for measurement of a concentration of peracetic acids. The test strips 700 may be placed into the stock 690. The test strips 700 are placed into the stock 690 in a vertically stacked manner. During step 2001 of the method 2000, the arrangement 610 is in its idle position and the force transmission 613, such as the force introduction element 611, may protrude partially or fully from the stock 690 and/or the housing of the arrangement 610 as can be seen in FIG. 4.

Method 2000 may continue with step 2002. Step 2002 may comprise activating the output mechanism 620 to output a single test strip 700 from the stack of test strips 700. Step 2002 may comprise pushing the test strip 700 in order to output it. Test strip 700 may be in an output position that allows a test strip 700 to be output trough the outlet opening 670 of the stock 690 and/or the opening of the housing of the arrangement 610. The output position of the test strip 700 may be the lowest position in the stack of test strips 700.

The step 2002 of activating the output mechanism 620 may comprise step 2002a of moving the force transmission 613 from the idle position shown in FIG. 4 to an activation position shown in FIG. 5 to activate the output mechanism 620, wherein the movement of the force transmission 613 from the idle position to the activation position can be induced by a gripper 510.

The step 2002 of activating the output mechanism 620 may comprise activating the linear drive 530. Activating the linear drive 530 may lead to a movement of the gripper 510, which is connected to the linear drive 530 via coupling rod 540, in a direction towards the arrangement 610 (“forward direction” or “forward movement”) and lead to step 2003 of pushing the single test strip 700 in the outlet position through the outlet opening (670, such as by the test strip pusher 650.

Forward movement of the gripper 510 may result in movement of the force transmission 613, such as the force introduction element 611, in the same direction by pushing it upon movement towards the arrangement 610, for example upon contact with the gripper 510. In embodiments featuring a spring 614 connected to force introduction element 611, forward movement of the force introduction element 611 may lead to compression of the spring 614 against a part of the stock 690 and/or the housing of the arrangement 610.

Forward movement of the force transmission 613, such as the force introduction element 611, may lead to the step 2003a of moving the linkage 630 via its connection to the force transmission 613, such as to the force transmitter 612. Moving of the linkage 630 may comprise pivoting around the pivot point 640.

Movement of the linkage 630 may result in the step 2003b of transmitting the movement of force transmission 613 into a movement of the test strip pusher 650 into an opposite direction to the forward direction. The movement of the test strip pusher 650 may be guided by the test strip pusher guide 660. Movement of the test strip pusher 650 may the result in the step 2003 of pushing the test strip 700 in the output position in the opposite direction as mentioned above. This may result in the test strip 700 being pushed through the opening 670 to a position that is substantially outside of the stock 690 and/or the housing of the device 600.

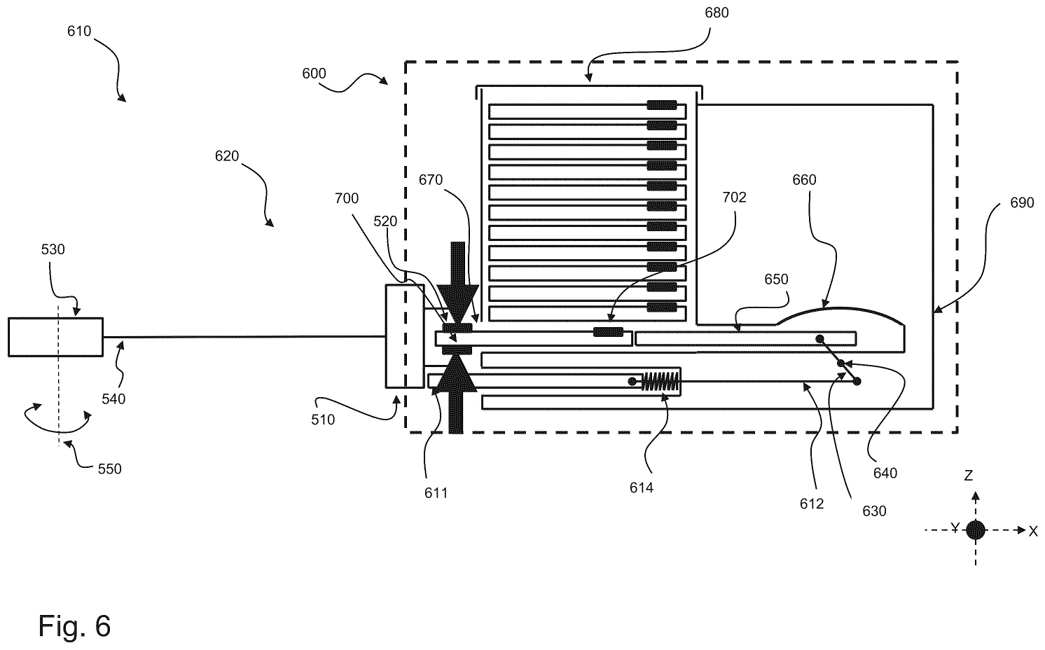

Method 2000 may continue with step 2004 of removing the single test strip 700 from the outlet opening 670, such as by the gripper 510, as shown in FIG. 6. This may comprise gripping the protruding test strip 700 with the gripper jaws 520 and retracting the gripper 510 together with the test strip 700 held by the gripper jaws 520.

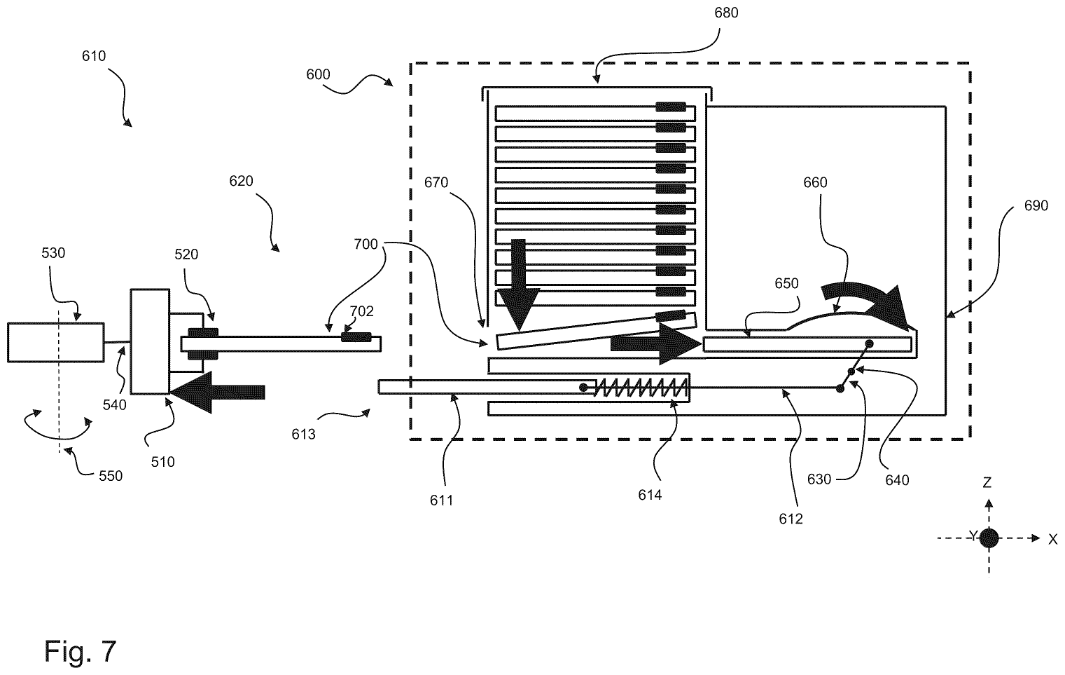

Method 2000 may continue with step 2005 of returning the force transmission 613 to its idle position after the test strip 700 is removed as shown in FIG. 7. This may happen when the gripper unit 510 moves away from the force transmission 613 and the previously compressed spring 614 may relax. This may lead to a movement of the force transmission 613 in the direction of the retracting gripper unit 510 and may cause the test strip pusher 650 to be pulled back to its initial position via linkage 630 and guided by the test strip pusher guide 660.

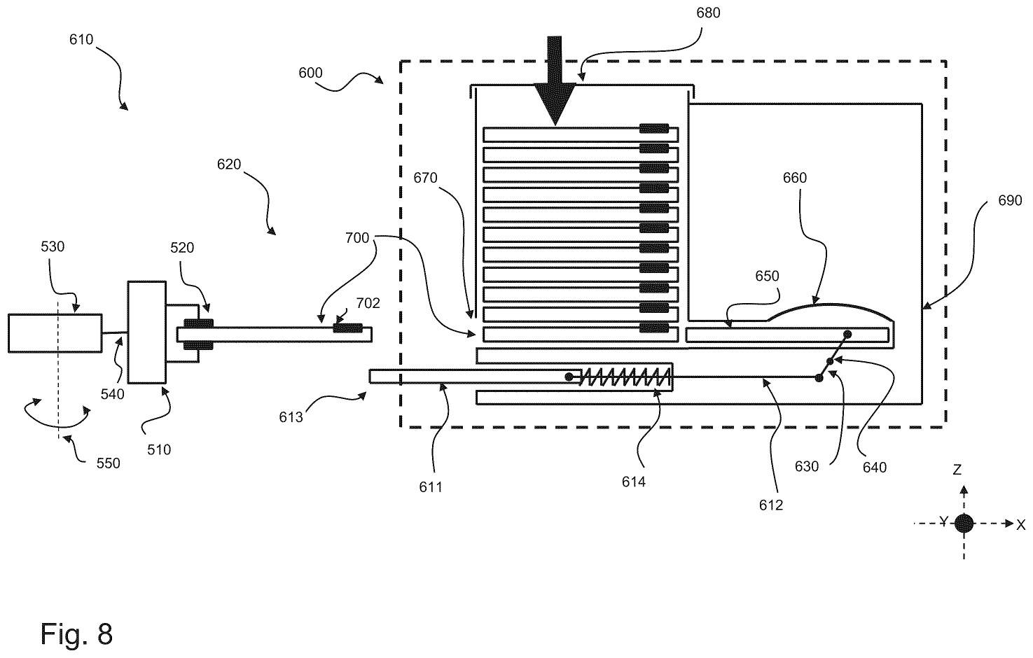

Now another, adjacent, test strip 700 from the stack of test strips 700 can move in step 2006 to the output position previously occupied by the now removed test strip as can be seen in FIG. 8. In an embodiment, in which the test strips 700 are vertically stacked inside the stock 690, the second test strip 700 moves into the position of the previous test strip due to gravity. Thus, the arrangement 610 may return to its idle position as shown in FIG. 8 after a test strip 700 has been removed from its output position.

While there has been shown and described what is considered to be embodiments of the invention, it will, of course, be understood that various modifications and changes in form or detail could readily be made without departing from the spirit of the invention. It is therefore intended that the invention be not limited to the exact forms described and illustrated, but should be constructed to cover all modifications that may fall within the scope of the appended claims.

What is claimed is:

1. An apparatus for separating a single test strip from a test strip depot containing a plurality of test strips, the apparatus comprising:
a stock containing the plurality of test strips;
an output position for the single test strip;
an outlet opening; and
an output mechanism configured to output the single test strip positioned in the output position through the outlet opening upon activation of the output mechanism.

2. The apparatus according to claim 1, wherein
the plurality of test strips are stacked vertically, in a direction of gravity; and
the output position is a lowest position in the plurality of test strips.

3. The apparatus according to claim 1, wherein the output mechanism is configured to output the single test strip by pushing the single test strip through the outlet opening.

4. The apparatus according to claim 1, wherein the output mechanism comprises a force transmission and the force transmission one or more of:
is moveable from an idle position to an activation position and configured to activate the output mechanism upon its movement to the activation position;
is biased in the idle position; and
protrudes from one of a stock or a housing of the apparatus in the idle position.

5. The apparatus according to claim 1, wherein the force transmission is biased in the idle position by a spring.

6. The apparatus according to claim 4, wherein
the force transmission is connected to a linkage, the linkage is supported on a pivot point and connected to a test strip pusher.

7. The apparatus according to claim 6, wherein the linkage is centrally supported on the pivot point.

8. The apparatus according to claim 6, wherein the linkage is configured to move about the pivot point when the force transmission is moved in a first direction and to transmit the movement of the force transmission into a movement of the test strip pusher in a second, opposite direction, with the test strip pusher being configured to push the test strip in the second, opposite direction.

9. The apparatus according to claim 4, wherein:
the force transmission comprises a force introduction element connected to a force transmitter;
wherein a force introduction element is supported by a spring; and
the linkage is connected to the force transmitter and the test strip pusher.

10. The apparatus according to claim 1, wherein the stock comprises an openable cover for filling the stock with the plurality of test strips.

11. The apparatus according to claim 6, further comprising a test strip pusher guide configured to allow a movement path of the linkage of the test strip pusher.

12. The apparatus according to claim 6, wherein the test strip pusher is configured to push the single test strip in the output position through the outlet opening.

13. The apparatus according to claim 1, wherein the output mechanism is configured to output the single test strip such that the single test strip can be removed from the outlet opening.

14. The apparatus according to claim 13, further comprising a gripper for removing the single test strip from the outlet opening.

15. A measuring apparatus for measuring a concentration of reprocessing agents in a reprocessing liquid used in a reprocessing apparatus for medical instruments, the measuring apparatus comprising an apparatus according to claim 1.

16. A reprocessing apparatus for medical instruments, the reprocessing apparatus comprising
a reprocessing chamber;
a reprocessing circuit; and
the measuring apparatus according to claim 15.

17. A reprocessing apparatus for medical instruments, the reprocessing apparatus comprising:
a reprocessing chamber;
a reprocessing circuit; and
the apparatus according to claim 1.

18. A method for separating a single test strip from a test strip depot containing a plurality of test strips, the method comprising:
providing the plurality of test strips in a stacked manner;
activating an output mechanism to output the single test strip positioned in an output position through an outlet opening.

19. The method according to claim 18, wherein the output mechanism outputs the single test strip by pushing the single test strip.

20. The method according to claim 18, wherein
the plurality of test strips are stacked vertically, in a direction of gravity; and
the output position is a lowest position in the plurality of test strips.

21. The method according to claim 20, further comprising one or more of:
moving a force transmission from an idle position to an activation position to activate the output mechanism;
pushing the single test strip in the outlet position through the outlet opening by the test strip pusher; and
removing the single test strip from the outlet opening.

22. The method according to claim 20, wherein:
the movement of the force transmission from the idle position to the activation position is induced by a gripper; and
the single test strip is removed from the outlet opening by the gripper.

23. The method according to claim 18, further comprising:
moving a linkage connected to the force transmission and to a test strip pusher about a central pivot point, when the force transmission is moved in a first direction, and
transmitting the movement of the force transmission into a movement of the test strip pusher in a second, opposite direction, with test strip pusher pushing the test strip in the second, opposite direction.

24. The method according to claim 22, further comprising returning the force transmission to its idle position after the test strip is removed, when the gripper moves away from the force transmission.

25. The method according to claim 18, wherein another, second, test strip from the plurality of test strips moves into the output position after the singe test strip has been outputted.
